(19) United States
(12) Patent Application Publication
(10) Pub. No.: US 2006/0167859 A1
(43) Pub. Date: Jul. 27, 2006

(54) System and method for personalized searching of television content using a reduced keypad

(76) Inventors: Timothy J.R. Verbeck Sibley, Washington, DC (US); Seth Michael Murray, Washington, DC (US)

Correspondence Address: BROOKS KUSHMAN P.C., 1000 TOWN CENTER, TWENTY-SECOND FLOOR, SOUTHFIELD, MI, 48075, US

(21) Appl. No.: 11/270,023

(22) Filed: Nov. 9, 2005

Related U.S. Application Data
(60) Provisional application No. 60/625,949, filed on Nov. 9, 2004.

(51) Int. Cl. G06F 17/30

(52) U.S. Cl. 707/3

(57) ABSTRACT

A method of searching television content for content of interest to a viewer involves entering a text search query with an ambiguous keypad device. The ambiguous keypad device includes a limited group of keys that represents a full set of alphanumeric characters. At least one key within the limited group represents multiple alphanumeric characters. Television content that matches the text search query is identified to produce a result set. The result set is ranked to provide a personalized result set that is prioritized for the viewer. The personalized result set is presented to the viewer.

### CROSS-REFERENCE TO RELATED APPLICATION

This application claims the benefit of U.S. Provisional Application No. 60/625,949, filed on Nov. 9, 2004.

### BACKGROUND OF THE INVENTION

1. Field of the Invention

The invention relates to the searching of television content for content of interest.

2. Background Art

As the volume of content available for television viewers through devices such as digital video recorders, set top boxes, DVDs, and broadcast television has increased, viewers have found it more difficult to find the content that they are interested in. Today's electronic programming guides (EPGs) and interactive programming guides (IPGs) are an attempt to alleviate this problem. However, the search functionality within these systems is limited by two factors.

The first limiting factor is the fact that most search systems are predicated on the input of a text query. However, the standard home entertainment setup does not include a keyboard that facilitates creating such a text query. The second limiting factor is the fact that due to the resolution of most television screens and the distance between the viewer and the television, only a small set of data can be displayed at any given time. Thus, only a limited set of search results can be displayed at any given time.

For the foregoing reasons, there is a need for an improved approach to the searching of television content for content of interest.

### SUMMARY OF THE INVENTION

It is an object of the invention to provide a system and method that address the problem of limited search functionality by combining the use of an ambiguous keypad device for text query entry with personalized ranking of query result sets.

The invention involves an ambiguous keypad device. The ambiguous keypad device is any device where any given key may be mapped to more than one alphanumeric character. For example, the ambiguous keypad device may be a remote control in a home entertainment environment. In this case, there are usually 10 keys that are associated uniquely with the numbers 0-9. Each of these keys could also be associated with two or three alphabetical characters so that the 10 keys would be associated with all 36 alphanumeric characters.

The invention further involves using the ambiguous keypad device to enter in a text search query. The search function may be provided in a variety of ways. For example, the search function may be included in an EPG or IPG viewer interface or another viewer interface enabled by the set top box, DVR, DVD, television, ambiguous keypad device, or a portable media player.

In a real-time query search approach, after each keystroke, the personalized result set based on the set of completed keystrokes for the given search query is displayed. In a full query search approach, the entire query is entered and then the personalized result set based on the completed string of keystrokes is displayed. In any approach to the search, the search queries are sent to a search engine. There are a wide variety of possibilities for implementing the search engine. Upon receiving the viewer's search query, the search engine identifies any content that matches the search query.

Because of the limited size of the television screen and the desire to optimize the ease of use, the search results must be prioritized for the viewer. In accordance with the invention, the result set is ranked based on a combination of factors to provide personalized ranking of query result sets. The combination of factors used to rank the search results could include a variety of factors.

In this way, embodiments of the invention provide personalized searching of television content using a reduced keypad. The combination of the ambiguous keypad device for text query entry with the personalized ranking of query result sets provides an approach to television content searching that facilitates input of the text query and appropriately and intelligently limits the displayed search results by conducting personalized ranking of query result sets. It is appreciated that the term “television content” means audio and/or video content and is not limited to any particular content structure.

### BRIEF DESCRIPTION OF THE DRAWINGS

FIG. 1 illustrates an exemplary ambiguous keypad that may be used in embodiments of the invention; and

FIG. 2 illustrates an ambiguous keypad device and the interaction with various components to carry out the personalized searching of television content using a reduced keypad.

### DETAILED DESCRIPTION OF THE PREFERRED EMBODIMENT

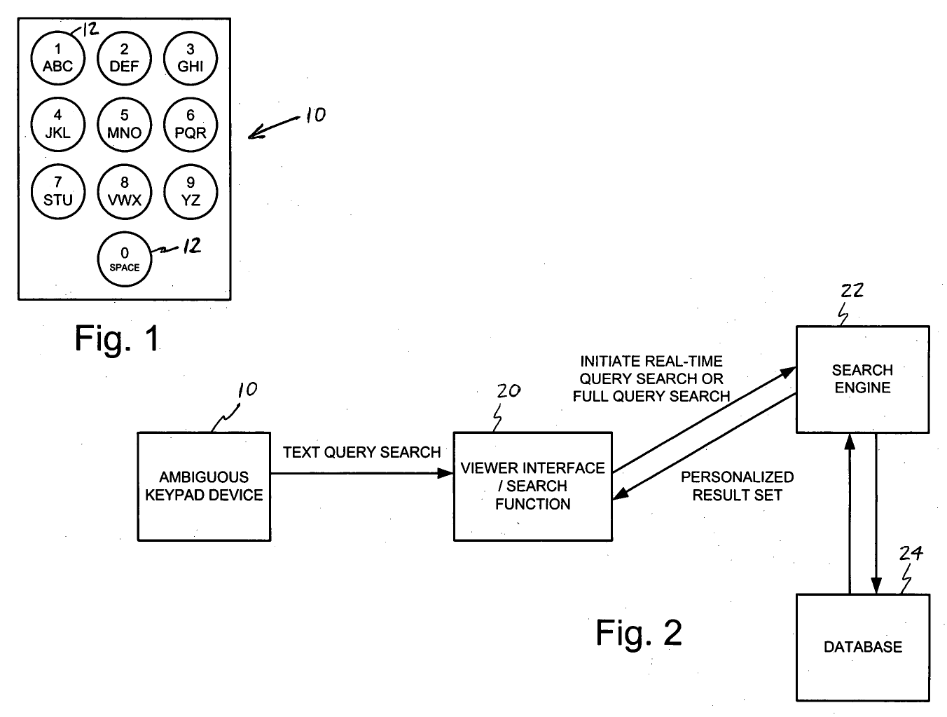

The ambiguous keypad device is any device where any given key may be mapped to more than one alphanumeric character. For instance, in the case of a remote control in a home entertainment environment, there are usually 10 keys that are associated uniquely with the numbers 0-9. Each of these keys could also be associated with two or three alphabetical characters so that the 10 keys would be associated with all 36 alphanumeric characters. Another frequently used ambiguous keypad device is a telephone keypad that has a limited number of keys. Note that the number of keys is not limited to 10, especially since many home entertainment remote controls have significantly more than 10 keys. An example of an ambiguous keypad, such as what might be included on a remote control device, is shown in FIG. 1. The keypad is generally indicated at 10, and includes a limited number of keys 12.

Using an ambiguous keypad device, the viewer would be able to enter in a text search query. This could be through a search function included in an EPG or IPG viewer interface or another viewer interface enabled by the set top box, DVR, DVD, television, ambiguous keypad device, or a portable media player. The system would have two modes in which it can analyze a viewer's search query:

1) After every keystroke, display the personalized result set based on the set of completed keystrokes for the given search query (thus the potential search results would be narrowed after each additional keystroke) (defined as “real-time query search”); or

2) After the viewer signals that the search query is completed (through the use of the Enter key or some similar method), display the personalized result set based on the completed string of keystrokes (defined as “full query search”).

In either case, the search queries are sent to a search engine. This search engine could reside on the DVR, set top box, television, or be at a remotely located server at the head-end or at some other location that may be accessed over the Internet or over some other data network. The search engine could query one or more databases. These databases may include information about content that has been stored on the viewer's DVR or portable media player, content that is available to the user through a video-on-demand library, a pay-per view system, or an upcoming or current broadcast as described in an EPG, IPG, or other television content guide, or content available on the Internet.

Upon receiving the viewer's search query, the search engine would identify any content that matches the search query.

An example of personalized searching according to the invention is depicted in FIG. 2. Ambiguous keypad device 10 is used to enter the text search query through a search function included in viewer interface 20. The search query is sent to search engine 22, using either a “real-time query search” approach or a “full query search” approach. Search engine 22 interacts with database 24 to identify content that matches the search query. The search results are prioritized for the viewer, and a personalized result set is sent to the viewer interface 20.

It is appreciated that although the search function is illustrated in FIG. 2 as being included in the viewer interface, the search function could be separated from the viewer interface. For example, the search interface may appear in the EPG, IPG or some other device and then simply pass commands to the search function which may or may not reside on the same machine.

For example, using the sample ambiguous keypad shown in FIG. 1, a viewer that was interested in watching the first episode of the second season of “The West Wing” could enter the search string “8277” on the viewer's remote control. As the viewer selects keys on the keypad, the system could continuously display potential word matches in addition to the potential television content matches. This query string would be sent to the search engine. Note that the search string is ambiguous since it could be any of eight potential words: “West,” “Western,” “Westerly,” “Westing,” “Vetta,” “Vette,” “Vets,” and “Wets.” Note that the user could very easily eliminate most of this ambiguity by expanding the query string to include the start or entirety of additional words. In this particular example, if the user entered “827708353” on the keypad, then the system would be able to resolve this to be “West Wing.” Thus, the search engine would identify potential results that match any of these potential words. For instance the set of matches could include the following titles:

Vette

1. Su tutte le vette e pace (1999)
   Vetta
2. Vetta (1984)
   Vets
3. It's a Vet's Life (1993)
4. Vets in Practice (1996)
5. Vets' School (1996)
6. Emergency Vets (1998)
7. Vets in the Wild (1998)
8. Vets in the Wild West (2001)
9. Vets in the Country (2000)
   Wets
0 matches
   West
10. The West Wing (1999)
11. West Side Story (1961)
12. Wild Wild West (1999)
13. How the West Was Won (1962)
14. Red Rock West (1992)
15. An American Tail: Fievel Goes West (1991)
16. West Beyrouth (1998)
17. Into the West (1992)
18. Way Out West (1937)
19. Batang West Side (2002)
20. South West 9 (2001)
21. The West (1996)
   Western
22. Western (1997)
23. Western (1989)
24. All Quiet on the Western Front (1930)
25. Decline of Western Civilization (1998)
26. Under Western Stars (1938)
27. 100 Years of the Hollywood Western (1994)
28. A Letter from the Western Front (1999)
29. Western Union (1941)
30. Playboy of the Western World (1962)
   Westerly
31. 1465 Westerly (2003)
   Westing
32. The Westing Game (1997)

At this point, the search engine could further expand the potential match set by performing various linguistic analyses, such as lemmatization, query expansion, or inclusion of partial word matches. Examples of each of these is provided below:

Lemmatization could expand the match set to include “Wet,” thus adding an additional eight search matches:
33. Bon Jovi: Slippery When Wet, the Videos (1987)
34. Wet (1995)
35. Wet (2004)
36. Wet Hot American Summer (2001)
37. Wet & Waan (2000)
38. Wet Blanket Policy (1948)
39. Dangerous When Wet (1953)
40. Wet and Dry (1997)

Query expansion could expand the match set by using an ontology or synonym list to include the term “Occident,” thus adding one more search match:
41. Occident (2002)

And inclusion of partial word matches could expand the match set to include “Yvette,” thus adding two more search matches:
42. Odile & Yvette at the Edge of the World (1993)
43. Cold War Love: The Story of Mark & Yvette McKoy (2003)

Similarly, the search engine could also match the search query to other metadata fields, including channel, actor, director, spoken words, descriptions, or other related metadata. All of these techniques result in a larger potential search result set.

Because of the limited size of the television screen and the desire to optimize the ease of use, this result set must be prioritized for the viewer. This result set would then be ranked based on a combination of factors that could include any of the following:

Personalized viewer information,

Statistical information of viewers' aggregated viewing habits,

Date and time of the search or the content creation,

Structural relationships between movies or television content (order of episodes in a given television or movie series, sequels and prequels to movies, news stories within a news broadcast, etc.),

Closeness of query string match,

Use of various natural language processing and/or statistical analyses (such as lemmatization, query expansion using ontologies or synonym lists, semantic similarity)

Category of match (e.g. title matches could be promoted),

Channel.

For instance, the system uses personalized viewer information to rank certain matches higher. In the earlier example with “The West Wing,” if the viewer had recently watched the last episode of the first season of “The West Wing,” then the system could use this information to determine that the viewer is more likely to be interested in viewing another episode of “The West Wing” relative to the other matches identified by the search engine. This information could be further combined with knowledge of the structural nature of television series like “The West Wing” so as to increase the ranking of the first episode of the second season of “The West Wing” since this is the episode that naturally follows “The West Wing” episode most recently watched by the viewer.

Other examples of ranking results based on personalized viewer information include:

Ranking search results for “Weather” (e.g. “8217326” or concatenation of this string using the sample ambiguous keypad) based on the viewer's zip code,

Ranking search results based on the viewer's viewing patterns at given times of the day or week (e.g. prioritizing television broadcasts of the Vikings football team based on the viewer's frequent searching for “Vikings” on Sunday afternoons (or “8343537” or a concatenation of this string using the sample ambiguous keypad)),

Ranking of matches based on their overall popularity or popularity among statistically similar viewers. For instance, if other viewers that have watched “The West Wing” have also watched “All Quiet on the Western Front” with greater frequency than the other potential matches, then the “All Quiet on the Western Front” result would receive a higher ranking.

Most importantly, the system would make use of both information about the user (both the history of past actions by the user and user-inputted information about their interests, location, etc.) and information about the content (both structured metadata and automatically generated information about the contents of the media and the information contained within the media) via semantic analysis.

For example, the system will not simply look for matches between past user searches and titles of available media. Rather, the system will recognize semantic properties of past user actions; thus, if the user has searched for movies that are western in the past, then that genre of media would be prioritized in a new search. Or if the user has looked for content about woodworking in the past (e.g. for searching for content about routers), then matches for the search being entered that concern woodworking (even if “woodworking” itself is not in the metadata for that content nor explicitly in the past user searches) would be prioritized.

Similarly, the system will use automatically detected information about the contents of media—through automatically performing natural language processing on media and cataloging the topics contained in the media and other characteristics of all or part of a media file, the system may find semantic reasons to prioritize a file beyond that indicated in the metadata for that file.

Users could also restrict search results by selecting a specific category that the search results should be restricted to (e.g. only display actor matches).

Some search results may be clustered together (episodes of a series or movies in a series) to facilitate browsing within the search results by the viewer.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of searching television content for content of interest to a viewer, the method comprising:
entering a text search query with an ambiguous keypad device, the ambiguous keypad device including a limited group of keys that represents a full set of alphanumeric characters, wherein at least one key within the limited group represents multiple alphanumeric characters;
receiving the text search query and identifying television content that matches the text search query to produce a result set;
ranking the result set to provide a personalized result set that is prioritized for the viewer; and
presenting the personalized result set to the viewer.

2. The method of claim of claim 1 wherein the ambiguous keypad device is a remote control in a home entertainment environment.

3. The method of claim 2 wherein the limited group of keys includes 10 keys that are associated with the numbers 0-9.

4. The method of claim 1 wherein the result set is produced and ranked to provide the personalized result set in accordance with a real-time query search approach such that, after each keystroke, the personalized result set is based on the set of completed keystrokes for the given search query.

5. The method of claim 1 wherein the result set is produced and ranked to provide the personalized result set in accordance with a full query search approach such that the entire query is entered and then the personalized result set is based on the completed string of keystrokes.

6. The method of claim 1 wherein the television content includes stored content on a digital video recorder.

7. The method of claim 1 wherein the television content includes content in a video on demand library.

8. The method of claim 1 wherein the television content includes content available on a pay per view basis.

9. The method of claim 1 wherein the television content includes upcoming broadcast content.

10. The method of claim 1 wherein the television content includes content available on the Internet.

11. The method of claim 1 wherein the television content includes stored content on a portable media player.

12. The method of claim 1 wherein identifying television content that matches the search query involves further expanding the result set by performing one or more types of linguistic analysis.

13. The method of claim 12 wherein the one or more types of linguistic analysis include lemmatization.

14. The method of claim 12 wherein the one or more types of linguistic analysis include query expansion.

15. The method of claim 12 wherein the one or more types of linguistic analysis include inclusion of partial word matches.

16. The method of claim 1 wherein identifying television content that matches the search query involves further expanding the result set by matching the search query to at least one metadata field of the television content.

17. The method of claim 1 wherein ranking the result set to provide the personalized result set involves consideration of information about the viewer and consideration of information about the television content.

18. The method of claim 1 wherein ranking the result set to provide the personalized result set involves consideration of information about the viewing habits of multiple users.

19. The method of claim 1 wherein ranking the result set to provide the personalized result set involves consideration of information about the search habits of multiple users.

20. A method of searching television content for content of interest to a viewer, the method comprising:
receiving an ambiguous text search query and identifying television content that matches the ambiguous text search query to produce a result set, the ambiguous text search query having been entered with an ambiguous keypad device, the ambiguous keypad device including a limited group of keys that represents a full set of alphanumeric characters, wherein at least one key within the limited group represents multiple alphanumeric characters, identifying the television content including resolving the text search query;
ranking the result set to provide a personalized result set that is prioritized for the viewer; and
presenting the personalized result set to the viewer.
